(19) United States
(12) Patent Application Publication
(10) Pub. No.: US 2015/0082390 A1
(43) Pub. Date: Mar. 19, 2015

(54) METHOD AND A SYSTEM FOR SECURE LOGIN TO A COMPUTER, COMPUTER NETWORK, AND COMPUTER WEBSITE USING BIOMETRICS AND A MOBILE COMPUTING WIRELESS ELECTRONIC COMMUNICATION DEVICE

(71) Applicant: YONA FLINK, TEL AVIV (IL)

(72) Inventor: YONA FLINK, TEL AVIV (IL)

(21) Appl. No.: 14/479,877

(22) Filed: Sep. 8, 2014

Related U.S. Application Data
(60) Provisional application No. 61/875,078, filed on Sep. 8, 2013.

(51) Int. Cl. H04L 29/06

(52) U.S. Cl. CPC H04L 63/0861; H04L 63/10
USPC 726/4

(57) ABSTRACT

A method of authenticating and certifying that the conducting party that is conducting at least one of: (i) secure login to a computer; (ii) secure login to a computer network; (iii) secure login to a computer website, is (i) the authorized conducting party authorized to login and (ii) using the conducting party's authorized mobile computing wireless electronic communication device to login. More particularly, the conducting party that conducts a login is not required to know or type in the conducting party's User Names and Passwords or required to remember or know a Username or Password. The authentication and certification of a conducting party is performed by using biometric technology means and a mobile computing wireless electronic communication device.

### BACKGROUND

1. Technical Field

The present invention relates generally to a biometric certification system and a method of authenticating and certifying that the conducting party that is conducting at least one of: (i) secure login to a computer; (ii) secure login to a computer network; (iii) secure login to a computer website, is (i) the authorized conducting party authorized to login and (ii) using the conducting party's authorized mobile computing wireless electronic communication device to login. More particularly, the conducting party that conducts a login is not required to know or type in the conducting party's User Names and Passwords or required to remember or know a Username or Password. The authentication and certification of a conducting party is performed by using biometric technology means and a mobile computing wireless electronic communication device.

2. Discussion of Related Art

The traditional method used today for login requires the conducting party to login using a unique User Name and a Password that is associated with the conducting party and used to identify the conducting party as the authorized party claimed. The conducting party is identified by the computer, computer network, and/or website by the conducting party's unique User Name and Password. In some cases, the conducting party is required to change their password periodically for security reasons. The periodic changing of passwords can result in the conducting party forgetting the new password that requires help desk assistance to authenticate the party requesting assistance with the new password that is time consuming and costly. Typing in User Names and Passwords often results in errors and denial of login access for a brief period or having to create a new password. Often, conducting parties are required to have different User Names and Passwords for login to different computer networks and websites. For example, Yahoo, Google, and Microsoft email accounts all require different User Names. Social sites such as Twitter, Facebook, and LinkedIn as well as businesses all require different User Names and Password that may result in conducting parties either forgetting all their different passwords or having to physically record all the different User Names and Passwords. Recording User Names and Passwords have a know history of being stolen and often result in account takeover, theft of confidential information, and in the case of online banking financial losses. Other means of login require a conducting party to possess one or more tokens or smartcards that produces One-Time Passwords for login or inserted into a special device connected to a computer that sends the encrypted data residing on the token or smartcard to a computer to confirm the authenticity of the encrypted data. If the data is confirmed as authentic, the conducting party is automatically logged in. More recently, biometrics has become an alternative method for replacing the traditional User Name and Password and tokens for login. An example of biometric login is speaker verification where a microphone is attached to a computer and the conducting party is requested to verbally repeat their password. Other methods of biometric login use fingerprints, face, and the vein patterns appearing in the palm of a conducting party's hand for authenticating a conducting party for login.

### BRIEF SUMMARY

Embodiments of the present invention provides methods and systems for identifying and authenticating that the party conducting a login is the claimed party authorized to login and not a third-party that may possess the conducting party's login information and gain unauthorized login privileges.

Further, information for login that is used by a conducting party for login remains unknown to a conducting party and is never stored on a conducting party's computer, biometric login device, or a conducting party's mobile, computing, wireless, electronic, communication device

Further, there is no need for a conducting party to know, remember or type in any type of information in order to login.

Embodiments of the present invention are implemented by the need for a secure software module to be installed on a conducting party's mobile, computing, wireless, electronic, communication device. The highest level of security is provided due to the elimination of the following requirements for a mobile, computing, wireless, electronic, communication device to possess in order for the invention to operate: (i) eliminates the need for storing the conducting party's personal and/or login information on a mobile, computing, wireless, electronic, communication device, (ii) eliminates the need for storing and or authenticating the conducting party's biometric samples on a mobile, computing, wireless, electronic, communication device, and (iii) eliminates the need for the conducting party to remember, protect or securely store login information known only to the conducting party.

These, and additional, and/or other aspects and/or advantages of the present invention are set forth in the detailed description which follows; possibly inferable from the detailed description; and/or learnable by practice of the present invention.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. In addition, it is to be understood that the phraseology and terminology employed herein is for the purpose of description and should not be regarded as limiting.

For a better understanding of the invention, the usages of the following terms in the present disclosure are defined in a non-limiting manner:

The term “biometrics”, as used herein in this application, is defined as the science and technology of measuring and analyzing biological samples. In information technology, biometrics refers to technologies that measure and analyze human body characteristics and patterns, such as DNA, fingerprint patterns, eye retinas and irises, voice, face, palm, and vein patterns for authentication purposes.

The Term “mobile, computing, wireless, electronic, communication device,” is defined as a mobile computing device that can communicate with other electronic communication devices, in a non-limiting manner, such as: (i) a computer, (ii) cellphones, (iii) smartphones, (iv) tablet, and (v) other computing devices.

The term, “SBL” (Secure Biometric Login), as used herein in this application, is defined as the biometric and technological system used for a conducting party to biometrically login to a computer, computer network, and computer website.

The term “SBL software module”, as used herein in this application, is defined as a module that encapsulates related functions on the mobile, computing, wireless, electronic, communication device that stores specific data and performs multiple functions, in a non-limiting manner, such as: (i) capturing biometric samples, (ii) storing data, (iii) decrypting and encrypting data, (iv) controlling one or more hardware devices and functions on the mobile, wireless, electronic, communication device, and (v) provide information and instruction to the Conducting Party what actions the conducting party is required to perform.

The term “authentication”, as used herein in this application, is defined as the process of validating the claimed identity of the conducting party.

The term “biometric authorization system”, as used herein in this application, is defined as a set of programs residing on one or more computers.

The term “Authorization Station Enroller”, as used herein in this application, is defined as a person certified by an Enterprise to authenticate the identity of the enrolling party requesting to enroll and provide the Enterprise Authenticating Computer with the enrolling party's required identity information.

The term “Enterprise Authorization Computer”, as used herein in this application, is defined as a computer that is connected to and oversees the operation of the Enterprise Biometric Computer and the Enterprise Internet Computer. In addition, the Enterprise Authorization Computer controls all login procedures and authorization, receives and sends data to the Enterprise Biometric Computer and Enterprise Internet Computer, handles the distribution of encryption keys, encrypting and decrypting data, assigning conducting parties with a unique digital identifier, authenticating QR codes, and controls security and procedural methods as described in the invention.

The term “Enterprise Biometric Computer”, as used herein in this application is defined as a computer in which the biometric verification system operates.

The term “Enterprise Internet Computer”, as used herein in this application is defined as a computer, which handles a website login and conducts all data exchanges between the website and conducting party's mobile, computing, wireless, electronic, communication device via the Internet

The term “MDI” is the Mobile Device Identifier, as used herein in this application, is defined as a unique alphanumeric digital string, created by the Enterprise Authorization Computer, sent to an enrolling party's mobile, computing, wireless, electronic, communication device and a conducting party's mobile, computing, wireless, electronic, communication device, and stored on the SBL software module that resides on the mobile, computing, wireless, electronic, communication device. The Enterprise Authorization Computer may replace the MDI periodically or randomly with a new MDI as defined by the Enterprise.

The term “biometric template”, as used herein in this application, is defined as a digital reference of distinct biometric characteristics that have been extracted from a biometric sample representing the unique biometrics of an enrolled party and used by the biometric system for comparison against subsequently submitted biometric samples during a biometric Authorization process.

The term “biometric acquiring device”, as used herein in this application, is defined as a hardware device by which a party's biometric samples may be captured and sent to a computer for creating biometric templates. A biometric acquiring device may be one or more of the following devices used separately, simultaneously, or in series: (i) fingerprint scanner, (ii) vein scanner, (iii) microphone, (iv) camera, (v) and/or any device that is capable of acquiring physical and/or behavioral biometric samples or characteristics of an enrolling and conducting party.

The term “login account”, as used herein in this application, is defined in a non-limiting manner, as an account that contains the following data: (i) an enrolling and conducting party's biometric and non-biometric identification data, (ii) the enrolling and conducting party's mobile, computing, wireless, electronic, communication device MDI, and (iii) any additional information that the Enterprise Authorization Computer may require in order to confirm the identity of the enrolling and conducting party on the Enterprise Authorization Computer and/or Enterprise Biometric Computer.

The term “Enterprise”, as used herein in this application, is defined as an organized body, business, or institution authorized, in a non-limiting manner to: (i) control the operations of one or more Enterprise Authorization Computer(s), Enterprise Internet Computer(s), and the Enterprise Biometric Computer(s) for the login to the Enterprise's computers, computer network(s), and computer website(s)

The term “Enterprise Internet Computer”, as used herein in this application, is defined as a computer operated by an Enterprise that is connected to the Internet for the purpose of enrollment and login to an Enterprise website.

The term “Enterprise Enrollment Page”, as used herein in this application, is defined as a website page that an enrolling party is required to provide the required enrolling party's identification information and the enrolling party's mobile, computing, wireless, electronic, communication device's mobile number in order to proceed with the party's enrollment.

The term “QR code”, as used herein in this application, is defined as an abbreviation for the trademark “Quick Response Code” or 2-D barcode that is similar to a linear (1-dimensional) barcode but represents more data per unit area.

The term “Authenticating QR code”, as used herein in this application, is defined as a unique, one-time QR code created by and stored on an Authorization Computer and on a Conducting Party's SBL software module for one-time mobile, computing, wireless, electronic, communication device identification and that may contain the following encrypted data in a non-limiting manner: (i) a unique MDI as the Enrolling Party's mobile, computing, wireless, electronic, communication device identifier (ii) one or more Encryption Keys, (iii) a unique one-time alpha numeric string for use by the SBL software module, and (iv) a time stamp and one-way hash function of all data contained in the Authenticating QR code.

The term “secure data packet” as used herein in this application, is defined as the encrypted data packet using encryption that may contain encryption keys sent by the Authorization Computer to the SBL software module residing on a conducting party's mobile, computing, wireless, electronic, communication device along with other means, in a non-limiting manner in order to obscure the data residing in the packets from non-authorized parties.

The term “communication line”, as used herein in this application, in a non-limiting manner, is defined as a line of communication that may be landline, wireless, or Internet.

The term “OOB”, as used herein in this application, is defined as an Out Of Band communication between two (2) or more devices utilizing two separate networks, channels, or lines of communication, one of which being different from the primary network or channel, simultaneously used to communicate between two parties or devices for identifying both the conducting party and the conducting party's mobile, computing, wireless, electronic, communication device.

The term “encryption”, as used herein in this application, is defined as a process of encoding plain text data in such a way that non-authorized parties or software programs are not capable of reading what is encrypted and only authorized parties and authorized programs are capable of reading and understanding the information or data. The invention does not limit in any way the type of encryption or the type of key or keys (both public and private) used to encrypt data.

The term “OTP”, as used herein in this application, is defined as a One Time Password that is valid for a single login session or transaction and may consist of one or more numbers, letters, and/or words.

The term “computer”, as used herein in this application, is defined as a PC, server, or virtual server.

The term “Enrolling Party”, as used herein in this application, is defined as the party undergoing enrollment by an Enterprise in order to become a Conducting Party.

The Term “Enterprise Enrollment Station”, as used herein in this application, is defined as an enrollment site located at physical premises where an enrollment computer and authorized member of the enterprise are stationed to assist enrolling person to conduct the enrollment process.

The term “Conducting Party”, as used herein in this application, is defined as a party that has successfully completed the SBL enrollment process and is permitted by the Enterprise to use the Conducting Party's mobile, computing, wireless, electronic, communication device for SBL login to the Enterprise computer(s), computer network(s), and/or website(s.

The term “GUI (Graphical User Interface) controller” as used in this application is defined as a graphical element, which enables interaction with the user and may trigger an action or execute a command in the application or software module as response to a user action in a non-limiting example: touching or swiping a finger on the graphical element or clicking the element using a pointing device such as a mouse or finger.

### BRIEF DESCRIPTION OF DRAWINGS

FIG. 1 describes the first stage of the enrollment procedures conducted by an enrolling party when an enrolling party enrolls at an enterprise's authorized website.

FIG. 2 describes the first stage of the enrollment procedures conducted by an enrolling party enrolling at an enterprise enrollment station.

FIG. 3 describes the second stage of enrollment procedures conducted by an Enrolling Party after successfully completing the first stage of enrollment and the procedure for completion of the enrollment process.

FIG. 4 describes the login procedures followed by a conducting party that has completed the enrollment process and is now an authorized Conducting Party using SBL login for login to an enterprise computer and enterprise computer networks.

FIG. 5 describes the login procedure followed by an authorized conducting party using a mobile computing wireless, electronic communication device to login to an enterprise computer and computer network.

FIG. 6 describes the login procedure followed by an authorized conducting party using a mobile computing wireless, electronic communication device to log in to an enterprise website or specific features of a website.

According to some embodiments of the invention, advantageously, the invention's biometric enrollment procedure provides the highest level for secure enrollment and login security presently available. The invention requires: (i) an enrolling party to provide to an enterprise documented proof of identity before an enrolling party is allowed to proceed with the enrollment process, (ii) both the enrolling and the conducting party must provide a enterprise authorization computer with one or more biometric samples in order to prove that the enrolling or the conducting party is the said party claimed, (iii) proof that an enrolling or conducting party's mobile, computing, wireless, electronic, communication device are operating a certified SBL software module designated to the specific enrolling or conducting party using a unique MDI, (iv) using OOB in order to authenticate the enrolling or conducting party's mobile, computing, wireless, electronic, communication device, and (iv) acquiring one or more biometric samples of the enrolling or the conducting party in order to confirm the identity of the claimed party using: (i) voice, (ii) face, (iii) fingerprint, (iv) iris, (v) hand, and or (vi) vein, in a non-limiting manner.

According to some embodiments of the invention, a party requesting SBL login privileges is required to first enroll with an Enterprise before a party can use SBL login.

A party wishing to receive login privileges using SBL login is required to have installed the SBL software module on the conducting party's mobile, computing, wireless, electronic, communication device. The SBL software module may come pre-installed by the mobile, computing, wireless, electronic, communication device vendor, pre-installed by the Mobile Network Operator, or the enrolling party is required to download from an authorized SBL website and install the SBL software module on the conducting party's mobile, computing, wireless, electronic, communication device. The SBL software module is non-operational for SBL login on a party's mobile, computing, wireless, electronic, communication device until the party has successfully completed the enrollment process. The enterprise may offer one or both of the following first stage enrollment options to an enrolling party: (i) an enrolling party may conduct the enrollment process on any computer and location that the enrolling party may wish to use in order to enroll, or (ii) an enrolling party may go to an Enterprise's authorized Enterprise enrollment station to conduct the enrollment process.

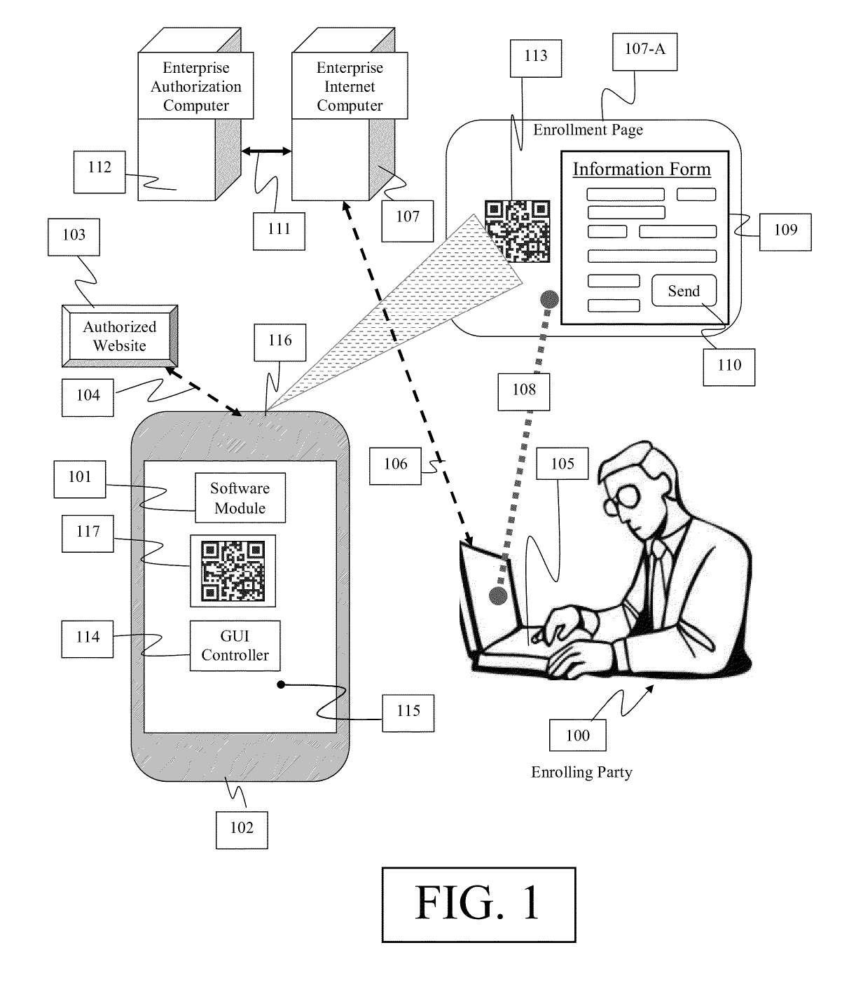

FIG. 1A is a diagram according to some embodiments of the invention, illustrating the first stage of the enrollment procedure followed by an enrolling party in order to enroll at an enterprise computer website.

We are now referring to FIG. 1 in the following description. Before an Enrolling Party 100 may begin the SBL login enrollment process, the Enrolling Party 100 must first have the SBL software module 101 installed on the Enrolling Party's mobile, computing, wireless, electronic, communication device 102. In the case that the Enrolling Party's 100 mobile, computing, wireless, electronic, communication device 102 does not have the SBL software module 101 pre-installed, the Enrolling Party 100 is required to connect to an Authorized Website 103 and download via a communication line 104 the SBL software module 101 to the Enrolling party's 100 mobile, computing, wireless, electronic, communication device 102. The Enrolling Party 100 then installs the SBL software module 101 on the Enrolling Party's 100 mobile, computing, wireless, electronic, communication device 102. The Enrolling Party 100 may then go to the Enrolling Party's 100 computer 105, connect to the Internet 106 and access the Enterprise Internet Computer 107. When the Enrolling Party 100 connects to the Enterprise Internet Computer 107, the Enrollment Page 107-A appears on the computer 105 screen 108. The Enrolling Party 100 is required to record in the text entry boxes appearing on the Information Form 109 the following information, in a non-limiting manner (i) Enrolling party's 100 identification information, (ii) the Enrolling Party's 100 mobile, computing, wireless, electronic, communication device 102 mobile phone number, and (iii) any additional information as may be required by the Enterprise Website Computer 107. Upon completion of the Information Form 107A, the Enrolling Party 100 clicks on the GUI controller ‘SEND’ 110, which then transmits from the Enterprise Internet Computer 107 the Information Form 109 data via the communication line 111 to the Enterprise Authorization Computer 112. The Enterprise Authorization Computer 112 upon receipt of the Enrolling Party's 100 Information Form 109 creates for the Enrolling Party 100 a one-time Authenticating QR code.

The Enterprise Authorization Computer 112 sends the Enrolling Party's 100 one-time Authenticating QR code via a communications line 111 to the Enterprise Internet Computer 107. Upon receipt of the Enrolling Party's 100 one-time Authenticating QR code 113 appears on the Enrolling party's 100 computer screen 108. The Enrolling Party 100 taps the SBL software module 101 GUI controller 114 residing on the mobile, computing, wireless, electronic, communication device's 102 screen 115, which now launches: (i) the back facing camera 116 and (ii) the display window 117 now appearing on the mobile, computing, wireless, electronic, communication device screen 115. The back-facing camera 116 captures the image of the Authenticating QR code 113 appearing on the Enrolling Party's 100 computer 105 screen 108 screen. When the Enrolling party's 100 mobile, computing, wireless, electronic, communication device 102 captures the image of the Authenticating QR code 113, an exact duplicate image of the QR code 113 appears in the displayed 117. The SBL software module 101 decrypts and processes the data from the captured Authenticating QR code 113 and stores the QR code 113 data on the SBL software module 101.

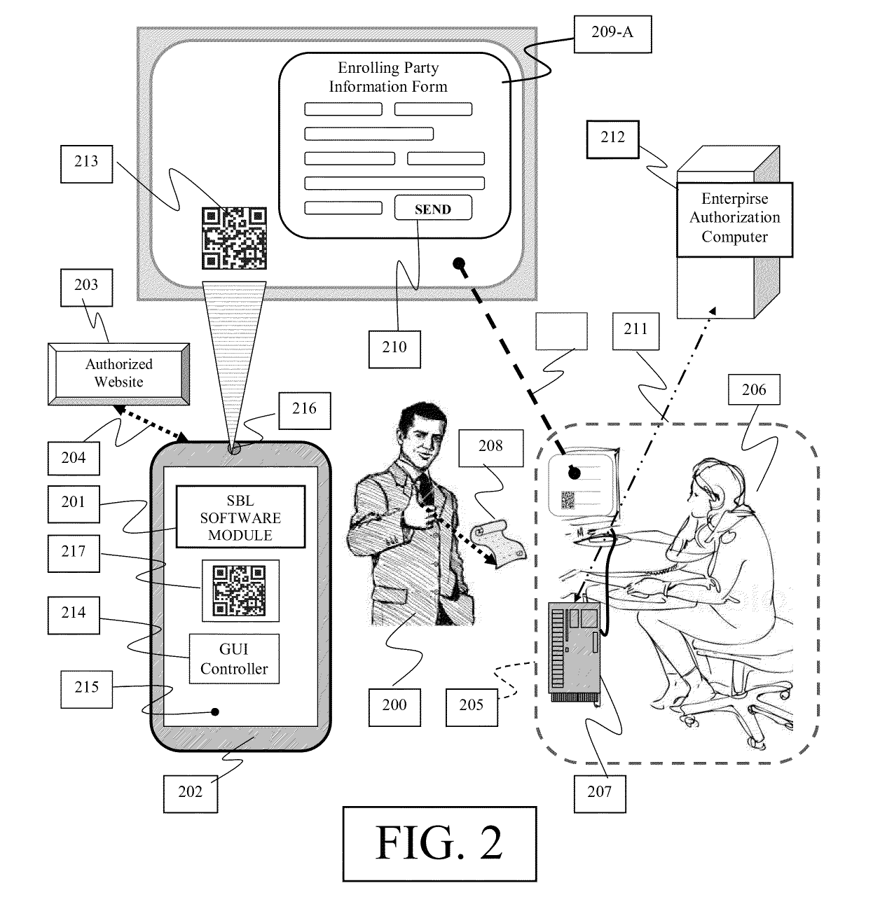

FIG. 2 is a diagram according to some embodiments of the invention, illustrating the first stage of the enrollment procedures followed by an enrolling party that is enrolling at an enterprise enrollment station.

We are now referring to FIG. 2 in the following description. Before an Enrolling Party 200 may begin the SBL login enrollment process the Enrolling Party 200 must first have the SBL software module 201 installed on the Enrolling Party's 200 mobile, computing, wireless, electronic, communication device 202. In the case that the Enrolling Party's 200 mobile, computing, wireless, electronic, communication device 202 does not have the SBL software module 201 pre-installed, the Enrolling Party 200 will be required to connect to an Authorized Website 203 and download via a communication line 204 the SBL software module 201 to the Enrolling Party's 200 mobile, computing, wireless, electronic, communication device 202. The Enrolling Party 200 then installs the SBL software module 201 on the Enrolling Party's 200 mobile, computing, wireless, electronic, communication device 202. The Enrolling Party may then go to any Enterprise Authorization Station 205 that may be located in one or more locations and provide to the Enterprise Authorization Station Enroller 206 documentation 208 that the Enrolling Party 200 requesting SBL login privileges is the Enrolling Party 200 as claimed.

If the Enrolling Party 200 is approved for enrollment by the Authorization Station Enroller 206, the Enrolling Party 200 may then be requested to provide the Authorization Station Enroller 206 with Enrolling Party's 200 mobile, computing, wireless, electronic, communication device's 202 mobile phone number. The Enrolling Party 200 provides the Authentication Station Enroller 206 with the Enrolling Party's 200 mobile, computing, wireless, electronic, communication device 202 mobile phone number. The Authorization Station Enroller 205 then records at the Authorization Station Enrollment Computer 207 the Enrolling Party's 200 documented identification information 208 and the Enrolling Party's 200 mobile, computing, wireless, electronic, communication device 202 mobile phone number in the Enrolling Party Information Form 209-A appearing on the Authorization Station Enrollment Computer 207 screen 209. The Authorization Station Enroller 206 then ‘clicks’ on the GUI controller SEND 210. The Authorization Station Enrollment computer 207 then sends the Enrolling Party Information Form 209-A via the secure communication line 211 to the Enterprise Authorization Computer 212. The Enterprise Authorization Computer 212 creates a one-time, Authenticating QR code for authenticating the Enrolling Party 200 mobile, computing, wireless, electronic, communication device 202.

The Authorization Computer 212 sends via the communications line 211 the Enrolling Party's 200 Authenticating QR code 213 to the Authorization Stations Computer 207 screen 209 where the Authenticating QR code 213 now appears.

The Enrolling Party 200 taps the SBL software module 201 GUI controller 214 residing on the mobile, computing, wireless, electronic, communication device 202 screen 215, which launches: (i) the back facing camera 216 and (ii) the display window 217 now appearing on the mobile, computing, wireless, electronic, communication device screen 215. The back-facing camera 216 captures the image of the Authenticating QR code 213 that now appears on the Authorization Stations Computer 208 screen 209. When the Enrolling party's 200 mobile, computing, m, wireless, electronic, communication device 202 captures the image of the Authenticating QR code 213, an exact duplicate image of the QR code 213 appears in the displayed 217. The SBL software module 201 decrypts and processes the data from the captured Authenticating QR code 213 and stores the QR code 213 data on the SBL software module 201.

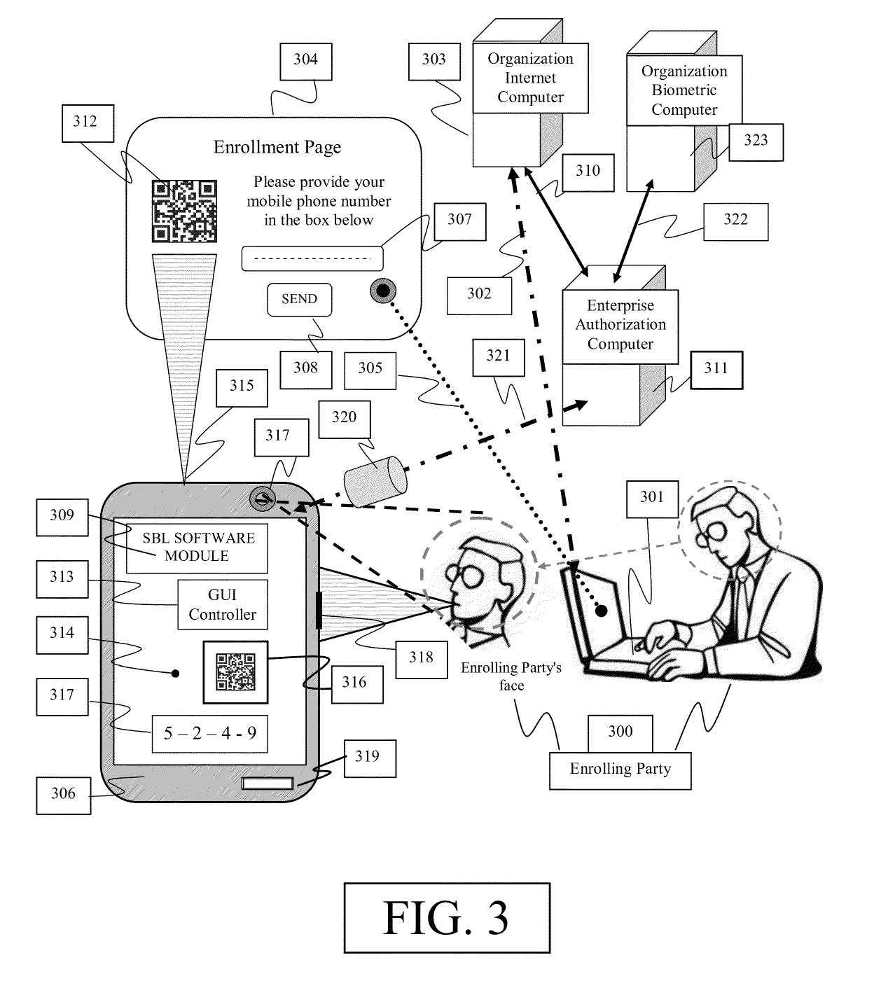

FIG. 3 is a diagram according to some embodiments of the invention, illustrating the procedures followed by an Enrolling Party that; (i) enrolled on a computer and location other than at an Enterprise's enrollment station to conduct the first stage of a two stage enrollment process, or (ii) enrolled at an Enterprise's authorized Enterprise enrollment station to conduct first stage of a two stage enrollment process. In order to complete the second and final stage of the enrollment process the enrolling party must complete the following procedures that will allow the Enrolling Party to become an authorized a Conducting Party.

We are now referring to FIG. 3 in the following description. The Enrolling Party 300 connects by means of the Enrolling Party's 300 computer 301 to the Internet 302. When the Enrolling Party's 300 computer 301 is connected to the Enterprise Internet Computer 303 the Enrollment Page 304 appears on the Conducting Party's 300 computer 301 screen 305. The Enrolling Party 300 types in the Enrolling Party's 300 mobile, computing, wireless, electronic, communication device 306 mobile phone number in the designated text entry box 307. The Enrolling Party 300 clicks on the GUI controller tab ‘SEND’ 308, which launches the SBL software module 309 that sends the Enrolling Party's 300 mobile, computing, wireless, electronic, communication device 306 mobile phone number via a communication line 302 to the Enterprise Internet Computer 303. The Enterprise Internet Computer 303 connects via a connection line 310 to the Enterprise Authorization Computer 311. The Enterprise Authorization Computer 311 generates a QR code 312 containing the following encrypted data in a non-limiting manner: (i) a OTP, (ii) a new MDI, (iii) one or more encryption keys, and (iv) any additional data as may be required in a non-limiting manner. The Authorization Computer 311 sends the QR code 312 via a communication line 310 to the Enterprise Internet Computer 303 where the QR code 312 appears on an Enrolling Party's 300 computer 301 screen 305.

The Enrolling Party 300 taps the GUI controller icon 313 appearing on the mobile, computing, wireless, electronic, communication device screen 314 that launches: (i) the SBL software module 309, (ii) the back-facing camera 315, and (iii) opens the display 316 appearing on the mobile, computing, wireless, electronic, communication device screen 314. The Conducting Party 300 focuses the mobile, computing, wireless, electronic, communication device 306 back-facing camera 315 on the QR code 312 appearing in the display 316. When the QR code 312 is correctly positioned in the QR code display 316, the SBL software module 309 acquires the QR code 312 image, retrieves the encrypted digital data stored in the QR code 312, decrypts the QR code 312 data, and performs the following in a non-limiting manner: (1) replaces the present MDI used by SBL software module 309 with a newly received MDI and (ii) the received OTP is now displayed in the OTP display 317.

The SBL software module 309 may now initiate the process of acquiring the Enrolling Party's 300 biometric sample or samples by using one or more of the following means existing on a mobile, computing, wireless, electronic, communication device, in a non-limiting manner (i) a microphone 318, (ii) the mobile, computing, wireless, electronic, communication device's 306 front facing camera 317, back facing camera 315, (iii) fingerprint sensor 319, and/or (iv) or any biometric acquiring device existing on a mobile, computing, wireless, electronic, communication device 306 or attached externally by wire or wireless means to a mobile, computing, wireless, electronic, communication device 306 that enables a mobile, computing, wireless, electronic, communication device 306 to capture and store biometric samples of the Enrolling Party 300.

The following are three different examples, in a non-limiting manner that a mobile, computing, wireless, electronic, communication device 306 may employ in order to obtain biometric samples from the Enrolling Party 300. The SBL software module 309, launches the OPT display 317 on the mobile, computing, wireless, electronic, communication device screen 314. In the OTP display 317, may appear: (i) a series of numbers, (ii) a series of words, or (iii) a combination of numbers and words, in a non-limiting manner. The Enrolling Party 300 is requested by the SBL software module 309 to verbally, repeat each number and/or word as they appear in the OTP display 317. The SBL software module 309 may optionally launch one or more additional biometric acquiring devices, in a non-limiting manner. The SBL software module 315 may launch the front-facing camera 317 in order to capture biometric samples of the Enrolling Party's 300 face or iris. The SBL software module 309 may optionally launch the biometric fingerprint acquiring device 319 in order to capture biometric samples of the Enrolling Party's 300 fingerprint(s) or finger vein pattern(s) using the biometric acquiring device 319 that may require the Enrolling Party 300 to place or swipe one or more of an Enrolling Party's 300 fingers on the biometric acquiring device 319. Another option, in a non-limiting manner, may be a biometric acquiring device that is either built in or connected to a mobile, computing, wireless, electronic, communication device 306 by wire or wireless means that may acquire physical and/or behavioral biometric characteristics of the Enrolling Party 300.

Upon acquiring physical and/or behavioral characteristics of the Enrolling Party 300, the SBL software module 309 may perform the following functions, in a non-limiting manner: (i) encrypts the previous MDI held before receiving the new MDI, (ii) encrypts the Enrolling Party's 300 acquired biometric sample or samples stored in the SBL software module 309, (iii) create and encrypt a time stamp, (iv) create and encrypt a one-way hash function of all the encrypted data, and (v) stores store the data in a secure data packet 320 with a data header and send the secure data packet 320 via a communication line 321 to an Enterprise Authorization Computer 311.

The Enterprise Authorization Computer 311 decrypts the secure data packet 321 received from the Enrolling Party's 300 mobile, computing, wireless, electronic, communication device 306. The Enterprise Authorization Computer 311 attaches to the biometric samples received from the Enrolling Party's 300 mobile, computing, wireless, electronic, communication device 306 a unique digital identifier that is associated with the Enrolling Party 300 and sends the biometric samples along with the Enrolling Party's 300 temporary digital identifier via the communication line 322 to the Enterprise Biometric Computer 323.

The Enterprise Biometric Computer 323 creates a biometric template from each of the Enrolling Party's 300 biometric samples received from the Enterprise Authorization Computer 311 and assigns the unique digital identifier received with the biometric samples of the Enrolling Party 300 from the Enterprise Authorization Computer 311 to the biometric samples and to the biometric templates stored on the Enterprise Biometric Computer 324. The Enterprise Biometric Computer 323 sends via a communication line 322 to the Enterprise Authorization Computer 311, in a non-limiting manner: (i) the Enrolling Party's 300 unique digital identifier and (ii) notification that the Enrolling Party's 300 biometric templates have been successful extracted from the Enrolling Party's 300 biometric samples, stored, and assigned to the Enrolling Party's 300.

In the case that the biometric samples of the Enrolling Party 300 are of insufficient quality to create biometric templates, the Enterprise Biometric Computer notifies the Enterprise Authorization Computer 311 via the communication line 322 that the biometric samples are of insufficient quality and biometric templates were not created. The Enterprise Authorization Computer 311 begins another enrollment process via communication line 321 of the Enrolling Party 300 on the Enrolling Party's 300 mobile, computing, wireless, electronic, communication device 306 until the Enterprise Biometric Computer 322 is able to create biometric templates from the Enrolling Party's 300 biometric samples.

Upon the successful creation of the Enrolling Party 300, the Enterprise Authorization Computer 310 now assigns the Enrolling Party 300 the unique digital identifier as the Enrolling Party's 300 permanent digital ID and biometric digital identifier.

Upon successful completion of the enrollment process, the Enrolling Party is now defined as the Conducting Party with SBL login privileges to login using SBL login to one or more of the Enterprise's computers, computer networks, and/or websites.

The Enrolling Party 300 may now receive notification, in a non-limiting manner, from the Enterprise Authorization Computer 311 that the Enrolling Party 300 is now an authorized Conducting Party.

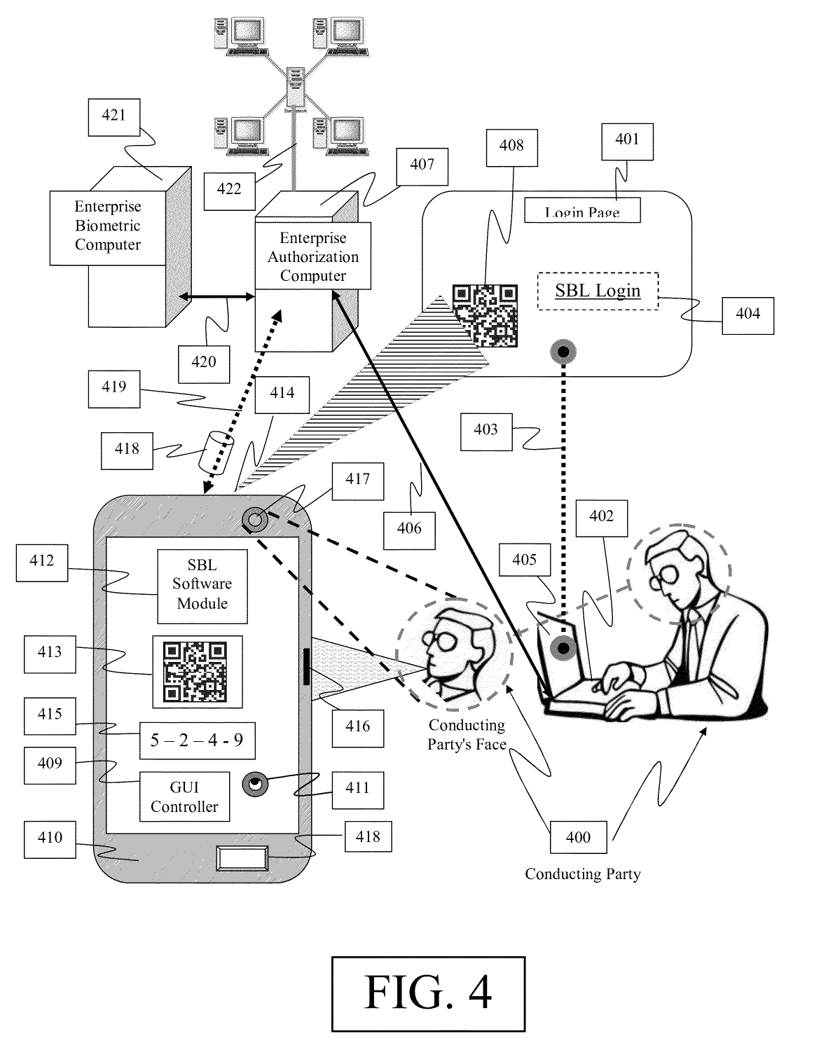

FIG. 4 is a diagram according to some embodiments of the invention, illustrating the procedures followed by a Conducting Party using SBL login for login to an enterprise computer and enterprise computer networks.

We are now referring to FIG. 4 in the following description. In order for the Conducting Party 400 to use SBL login for login to: (i) a computer and/or (ii) a computer network, the Conducting Party 400 begins by going to the SBL login page 401 appearing on the Conducting Party's 400 computer 402 screen 403. The Conducting Party 400 begins the login process by clicking on the SBL Login GUI controller 404. SBL Login GUI Controller 404 launches SBL application 405 residing on the Conducting Party's 400 computer 402 web browser connected to the enterprise network 406 sends via the communication line 406 a request to the Enterprise Authorization Server that an unknown party requests login privilege to the computer 402. The Enterprise Authorization Computer 407 creates an Authenticating QR code 408 and sends the Authenticating QR code 408 via a communication line 406 to a Conducting Party's 400 Login Page 401 that appears on the Conducting Party's 400 computer screen 403.

The Conducting Party 400 clicks on the GUI controller icon 409 appearing on Conducting Party's 400 mobile, computing, wireless, electronic, communication device 410 screen 411 that launches: (i) the SBL software module 412, (ii) the back-facing camera 414, and (iii) opens the display 413 appearing on the mobile, computing, wireless, electronic, communication device screen 411. The Conducting Party 400 focuses the back-facing camera 414 on the QR code 408 appearing on the computer screen 403. When the QR code 408 is correctly positioned in the QR code display 413, the SBL software module 412 acquires the QR code 408 image, retrieves the encrypted digital data stored in the QR code 408, decrypts the QR code 408 data, and performs the following actions in a non-limiting manner: (i) replaces the present MDI used by SBL software module 412 with a newly received MDI, (ii) receives and holds one or more encryption keys, (iii) the received OTP and displayed in the OTP display 415, and (iv) receives and holds any additional QR code data.

The SBL software module 412 then initiates the process of acquiring one or more of the Conducting Party's 400 biometric sample(s) by using one or more of the following means existing on a mobile, computing, wireless, electronic, communication device, in a non-limiting manner (i) the microphone 416, (ii) the front facing camera 417, (iii) fingerprint sensor 418, and/or (iv) any biometric acquiring device existing on a mobile, computing, wireless, electronic, communication device 410 or attached externally by wire or wireless means to the mobile, computing, wireless, electronic, communication device 410 that enables the mobile, computing, wireless, electronic, communication device 410 to acquire and store biometric samples of the Conducting Party 400.

The following are three examples, in a non-limiting manner, that the mobile, computing, wireless, electronic, communication device 410 may employ in order to obtain biometric samples from the Conduct Party 400. The SBL software module 412 may display 415 on the mobile, computing, wireless, electronic, communication device's screen 411 in a non-limiting manner: (i) a series of numbers, (ii) a series of words, or (iii) a series of numbers and words. In the display 415 may also appears a text message sent by the SBL software module 412 instructing the Conducting Party 400 to verbally repeat each number and/or word as they appear in the display 415 while facing the front-facing camera 417. The SBL software module 412 now records the Conducting Party's 400 verbal OTP and at the same time the front-facing camera 417 may optionally captures biometric samples of the Conducting Party's 400 face. The SBL software module 412 may optionally capture biometric samples of the Conducting Party's 400 fingerprint(s) or finger vein pattern(s) using a biometric acquiring device 418. A biometric acquiring device may be either built in or connected to a mobile, computing, wireless, electronic, communication device 410 by wire or wireless means that may acquire physical and/or additional behavioral biometric characteristics of the Conducting Party 400.

Upon acquiring physical and/or behavioral samples of the Enrolling Party 400 from a biometric acquiring device, the SBL software module 412 may perform the following procedure, in a non-limiting manner: (i) encrypt the Conducting Party's 400 physical and/or behavior biometric samples, (ii) encrypt the MDI, (iii) encrypt the biometric samples acquired by the SBL software module 412 from the Conducting Party 400, (iv) attach a time stamp, (v) attach a one-way hash function of all the encrypted data and (vi) stores the data in a secure packet 418 with a data header and (vii) send the secure packet 418 via a communication line 419 to an Enterprise Authorization Computer 407.

The Enterprise Authorization Computer 407 decrypts the encrypted data in the secure packet 418 received from the Conducting Party's 400 mobile, computing, wireless, electronic, communication device 410. An Enterprise Authorization Computer 407 may then send the biometric samples via a communication line 420 to an Enterprise Biometric Computer 421. The Enterprise Biometric Computer 421 now creates a biometric template from each of the received biometric samples of the Conducting Party 400 and compares them with stored biometric templates of the Conducting Party 400 in order to determine the level of similarity between the biometric templates created from the Conducting Party's 400 biometric samples and the stored biometric templates of the Conducting Party 400. The Enterprise Biometric Computer 421 determines the level of similarity and sends to the Enterprise Authorization Computer 407 the level of similarity. The Enterprise Authorization computer 407, based on the level of similarity, may allow or deny login to the computer 402 and/or access to the computer network 422

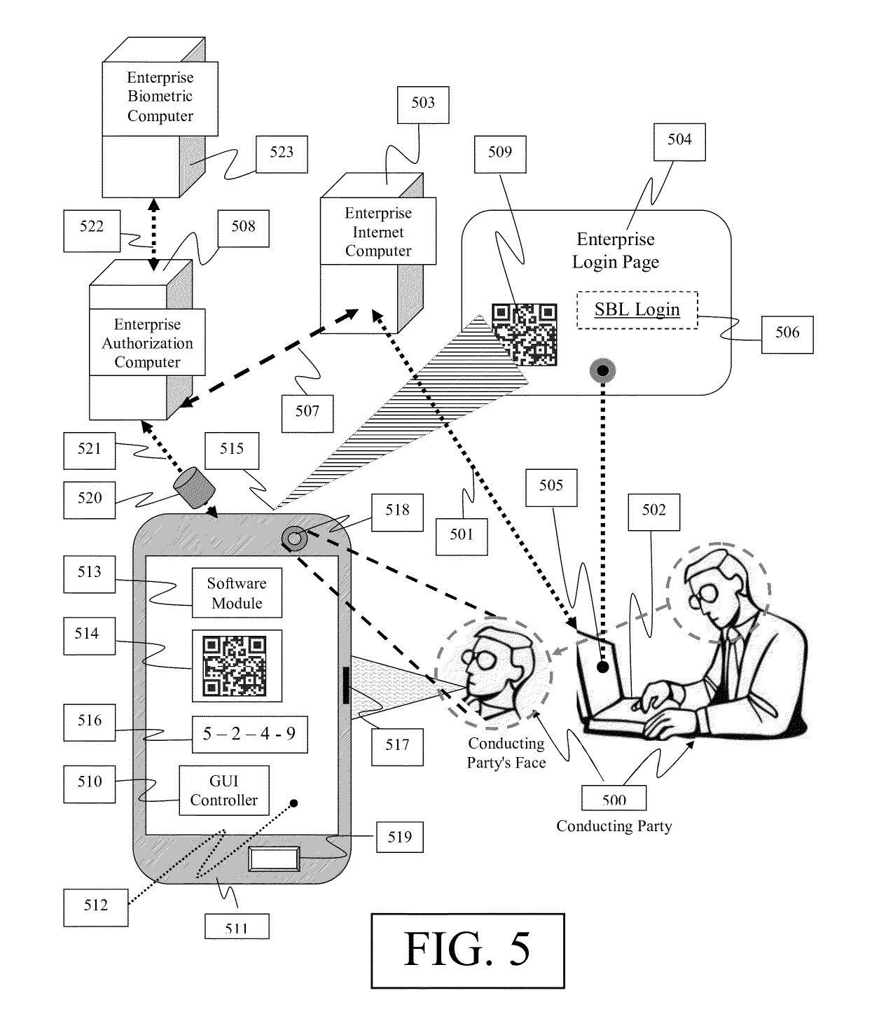

FIG. 5 is a diagram according to some embodiments of the invention, illustrating the login procedure required by a conducting party in order to login to an Enterprise Website using SBL login.

We are now referring to FIG. 5 in the following description. In order for the Conducting Party 500 to log into an SBL enterprise website, the Conducting Party 500 first connects to the Internet 501 on the Conducting Party's 500 computer 502. Upon connecting to the Internet 501, the Conducting Party 500 may now go to the Enterprise Internet Computer 503 website Login Page 504 that appears on the Conducting Party's 500 computer screen 505, the Conducting Party 500 clicks on the GUI controller SBL Login 506. When the Conducting Party 500 clicks on GUI controller SBL Login 506, the Enterprise Internet Computer 508 sends via a communication line 507 a request to the Enterprise Authorization Computer 508 for a Login Authenticating QR code. The Enterprise Authorization Computer 508 creates a Login Authenticating QR code. The Enterprise Authorization Computer 508 sends the Login Authenticating QR code via the communication line 507 to Enterprise Internet Computer. When the Login Authenticating QR code is received by the Enterprise Internet Computer 503, the received Login Authenticating QR code now appears as the Authenticating QR Code 509 on the Enterprise Login Page 504 on the Conducting Party's 500 computer screen 505. The Conducting Party's 500 may now tap the GUI controller 510 appearing on Conducting Party's 500 mobile, computing, wireless, electronic, communication device 511 screen 512. The GUI controller 510 now launches the SBL software module 513. The SBL software module 513 launches the display window 514 appearing on the mobile, computing, wireless, electronic, communication device screen 512. Simultaneously, the GUI controller launches the back-facing camera 515. The conducting part 500 now focuses the back-facing camera 515 on the QR code 509 appearing on the Conducting Party's 500 computer screen 505. When the QR code 509 is correctly positioned in the display 514, the SBL software module 513 acquires the QR code image decrypts the QR code 509 data and performs the following actions in a non-limiting manner: (i) stores all the QR Code 509 data in the SBL software module, and (ii) sends the received OTP to appear in the display 516.

The SBL software module 513 then initiates the process of acquiring the Conducting Party's 500 biometric sample by using one or more of the following means existing on a mobile, computing, wireless, electronic, communication device, in a non-limiting manner (i) the microphone 517, (ii) the mobile, computing, wireless, electronic, communication device's 511 front facing camera 518 and or back facing camera 515, (iii) fingerprint sensor 519, and/or (iv) or any biometric acquiring device existing on the Conducting Party's mobile, computing, wireless, electronic, communication device 511 or attached externally by wire or wireless means to a mobile, computing, wireless, electronic, communication device 511 that enables a mobile, computing, wireless, electronic, communication device 511 to acquire and store biometric samples of the Conducting Party 500.

The following are three examples, in a non-limiting manner, that the mobile, computing, wireless, electronic, communication device 511 may employ in order to obtain biometric samples from the Conduct Party 500. The SBL software module 513 may display on the mobile, computing, wireless, electronic, communication device's screen 512, in a non-limiting manner: (i) a series of numbers, (ii) a series of words, or (iii) a series of numbers and words. In the display 514 now appears a text message sent by the SBL software module 513 instructing the Conducting Party 500 to verbally repeat each number and/or word as they appear in the display 516 while facing the front-facing camera 518. The SBL software module 513 now records the Conducting Party's 500 verbal OTP via the microphone 517 and at the same time the front-facing camera 518 may optionally capture biometric samples of the Conducting Party's 500 face. The SBL software module 513 may optionally capture biometric samples of the Conducting Party's 500 fingerprint(s) or finger vein pattern(s) using a biometric acquiring device 519. A biometric acquiring device may be either built in or connected to a mobile, computing, wireless, electronic, communication device 511 by wire or wireless means that may acquire other physical and/or behavioral biometric characteristics of the Conducting Party 500.

Upon acquiring physical and/or behavioral samples of the Enrolling Party 500 from a biometric acquiring device, the SBL software module 513 may performs the following procedure, in a non-limiting manner: (i) encrypts the Conducting Party's 400 physical and/or behavior biometric samples, (ii) encrypts the MDI, (iii) encrypts the biometric samples acquired by the SBL software module 513 from the Conducting Party 500, (iv) attach a time tamp, (v) attach a one-way hash function of all the encrypted data and (vi) stores the data in a secure packet 520 with a data header and send the secure packet 520 via a communication line 521 to an Enterprise Authorization Computer 508.

The Enterprise Authorization Computer 508 decrypts the encrypted data in the secure packet 520 received from the Conducting Party's 500 mobile, computing, wireless, electronic, communication device 511. An Enterprise Authorization Computer 508 may then send the biometric samples via a communication line 522 to an Enterprise Biometric Computer 523. The Enterprise Biometric Computer then creates a biometric template from each the received biometric samples of the Conducting Party 500 and compares them with stored biometric templates of the Conducting Party 500 in order to determine the level of similarity between the biometric templates created from the Conducting Party's 500 biometric samples and the stored biometric templates. The Enterprise Biometric Computer 523 determines the level of similarity and sends to the Enterprise Authorization Computer 508 the level of similarity. The Enterprise Authorization computer 508, based on the level of similarity, may allow or deny login to the Website 504 and/or the Enterprise Internet Computer 503.

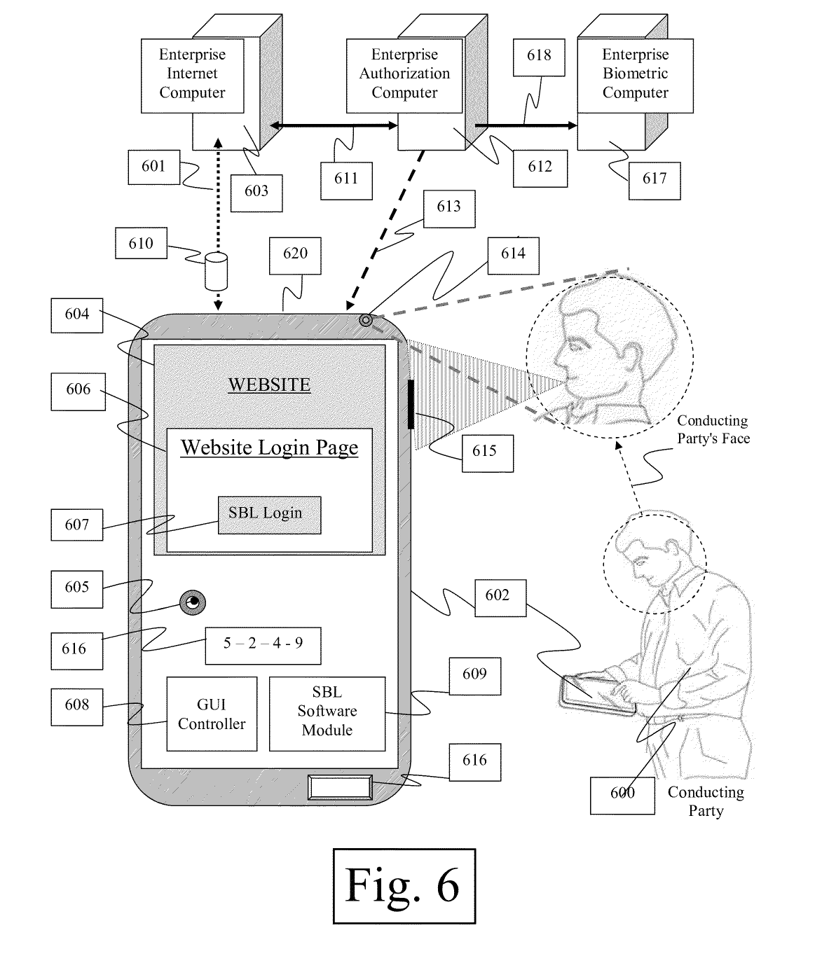

FIG. 6 is a diagram according to some embodiments of the invention, illustrating the procedure followed by a conducting party using a mobile, computing, wireless, electronic, communication device to log in to an enterprise website or specific features of a website.

We are now referring to FIG. 6 in the following description. According to some embodiments of the invention, The Conducting Party 600 connects to the Internet 601 from a Conducting Party's 600 mobile, computing, wireless, electronic, communication device 602. When Conducting Party 600 is connected to the Internet 601, the Conducting Party may now connect to the Enterprise Website Computer 603. The Website Login Page 604 now appears on Conducting Party's 600 mobile, computing, wireless, electronic, communication device 602 screen 605. The Conducting Party 600 now proceeds to the Website Login Page 606 where the SBL Login GUI controller icon 607 is located. The Conducting Party 600 taps the SBL Login GUI controller icon 608 residing on the Conducting Party's 600 mobile, computing, wireless, electronic, communication device 602, which launches the SBL software module 609 residing on the Conducting Party's 600 mobile, computing, wireless, electronic, communication device 602.

When the Conducting Party 600 clicks on the SBL login icon 607, the SBL login icon 607 sends via the communications line 601 an encrypted data packet 610 with a data header containing the Conducting Party's 600 mobile, computing, wireless, electronic, communication device 602 MDI to the Enterprise Internet Computer 603. Upon receipt of the secure data packet 610 from the Conducting Party 600, the Enterprise Website Computer sends the secure data packet 610 with a data header via a communication line 611 to the Enterprise Authorization Computer 612. The Enterprise Authorization Computer 612 decrypts the MDI, which identifies the mobile, computing, wireless, electronic, communication device 602 and the mobile, computing, wireless, electronic, communication device's 602 mobile phone number stored by the Enterprise Authorization Computer 612. The Enterprise Authorization Computer sends via an OOB communications line 613 an encrypted SMS message to the Conducting Party's 600 SBL software module containing the following data, in a non-limiting manner: (i) a new MDI, (ii) the OTP, and (iii) one or more encryption keys.

The SBL software module 609 decrypts the data packet 610 with instructions to the SBL software module 609 to send to the Enterprise Authorization Computer 611 via the Internet connection 601 an encrypted data packet 610 containing the following data, in a non-limiting manner: (i) one or more biometric samples of the Conducting Party 600 (ii) the mobile, computing, wireless, electronic, communication device 602 MDI, (iii) a time stamp, (iv) a one-way hash function of all the sent data to the Enterprise Authorization Computer 507, and (v) send the data packet 610 via the Internet 601 to Enterprise Internet Computer 603.

The SBL software module 609 may now begin the process of acquiring one or more of the Conducting Party's 600 biometric samples by using one or more of the following means existing on the mobile, computing, wireless, electronic, communication device 602 for acquiring biometric samples, in a non-limiting manner using: (i) the front facing camera 614, (ii) the microphone 615, (iii) the fingerprint sensor 616, (iv) the back facing camera 620 and/or (v) or any other biometric acquiring device that may be used on the mobile, computing, wireless, electronic, communication device 602. In addition, the SBL software module 609 may now acquiring biometric samples from a device or devices attached externally by wire or wireless means to a mobile, computing, wireless, electronic, communication device 602 that enables the mobile, computing, wireless, electronic, communication device 602 to acquire and send biometric samples of the Conducting Party 600 to the SBL software module 609.

The following are three examples, in a non-limiting manner, that the mobile, computing, wireless, electronic, communication device 602 may employ in order to acquire biometric samples from the Conduct Party 600. The SBL software module 609, opens the display 616 on the mobile, computing, wireless, electronic, communication device 602 screen 605. In the display 616 may appear, in a non-limiting manner: (i) a series of numbers, (ii) a series of words, or (iii) a series of numbers and words. The SBL software module 609 instructs the Conducting Party 600 to verbally repeat each number and/or word as they appear in the display 616 at which time the SBL software module 609 begins the process of recording the Conducting Party's 600 speech via the microphone 615. The SBL software module 609 may also launch the following biometric acquiring devices, in a non-limiting manner: (i) the front-facing camera 614 to capture biometric samples from the Conducting Party's 600 facial images, (ii) the fingerprint sensor 616, and/or (iii) or any other biometric acquiring device that may be installed on the mobile, computing, wireless, electronic, communication device 602 or a biometric acquiring device that may be attached externally by wire or wireless means to a mobile, computing, wireless, electronic, communication device 602 that enables the mobile, computing, wireless, electronic, communication device 602 to acquire and send biometric samples of the Conducting Party 600 to the SBL software module 608 and temporarily stores the captured biometric samples until sent to the Enterprise Internet Computer 603.

The SBL software module 609, upon acquiring biometric samples of the Conducting Party 600 from one or more biometric acquiring devices, the SBL software module 609 may perform one or more of the following procedures, in a non-limiting manner: (i) encrypt the Conducting Party's 500 biometric samples, (ii) encrypt the MDI, (iii) create and encrypt a time stamp, (iv) create and encrypt a one-way hash function of all the data that is to be sent to the Enterprise Internet Computer 603, (v) store the encrypted data in a secure digital packet 610 with a data header, and (vi) send the secure data packet 610 via the Internet 601 to the Enterprise Internet Computer 603.

The Enterprise Internet Computer 603 upon receipt of the secure data packet 610 sends via communications line 611 the secure digital packet 610 to the Enterprise Authorization Computer 612. The Enterprise Authorization Computer 612 opens the secure data packet and decrypts the encrypted data in the secure data packet 610 received from the Conducting Party 600. The Enterprise Authorization Computer 612 may then send the Conducting Party's 600 biometric samples via the communication line 618 to the Enterprise Biometric Computer 617. The Enterprise Biometric Computer 617 creates a biometric template from each the received biometric samples of the Conducting Party 600 and compares them with stored biometric templates of the Conducting Party 600 in order to determine the level of similarity between the biometric templates created from the Conducting Party's 600 biometric samples and the stored biometric templates. An Enterprise Biometric Computer 617 determines the level of similarity and sends to the Enterprise Authorization Computer 612 the level of similarity. The Enterprise Authorization computer 612, based on the level of similarity, may allow or deny login to the Conducting Party 600 SBL login to the web site 604

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the present invention.

1. A method of conducting a login transaction on a computer, computer network, and online computer website comprising:
i) enrolling a conducting party with an authenticating party at a physical and/or at an unmanned authenticating computer, wherein enrollment comprises receiving from the conducting party documented proof of identity. Biometric identifying samples of the conducting party and receiving from the conducting party personal and mobile, computing, wireless, electronic, communication device information through which the conducting party will conduct login transactions that can identify both the conducting party and the conducting party's mobile, computing, wireless, electronic, communication device used for login;
ii) receiving, at the authenticating party or at the unmanned authenticating computer, information relating to the mobile, computing, wireless, electronic, communication device that the conducting party will use for login;
iii) communicating, based on the enrollment, with the conducting party to authenticate that the conducting party is a party that performed the login and authorized to login to the computer, computer network, and/or online computer website;
iv) transferring data based on the authentification, from the authenticating computer and authorization for login to a computer, computer network, and online computer website;
v) wherein at least one of the conducting, receiving, communicating, and/or transferring of data, is performed by at least one or more computers.

2. The method according to claim 1, wherein identifying information compromises biometric information, and mobile, computing, wireless, electronic, communication device information.

3. The method according to claim 2, wherein the biometric information comprises at least one of a voice sample of the conducting party and/or alternative biometric samples of the conducting party.

4. The method according to claim 2, wherein the mobile, computing, wireless, electronic, communication device information compromises at least one of the mobile, computing, wireless, electronic, communication device's phone number and a unique digital identifier given to the mobile, computing, wireless, electronic, communication device by the authenticating party.

5. The method according to claim 1, wherein the enrollment comprises the enrolling party to provide proof of identity to an authenticating party and the authenticating party filling out an electronic form containing the enrolling party's identification information and mobile, computing, wireless, electronic, communication device mobile phone number at a physical premise, or the enrolling party to provide proof of identity at an unmanned computer provided by the authenticating party and the enrolling party filling out an electronic form containing the enrolling party's identification information and the mobile, computing, wireless, electronic, communication device mobile phone number.

6. The method according to claim 1, wherein the communication information comprises of the mobile phone numbers of the enrolling party.

7. The method according to claim 1, wherein all communications between the conducting party and login to a computer, computer network, and an online computer website is conducted through one or more of the authenticating party's computers.

8. A system for conducting a login to a computer, computer network, and online computer website; comprising:
a) one or more computers adapted to operate in a communications network, wherein, the one or more computers are adapted to communicate with one or more authenticating party computers to enroll an enrolling party with an authenticating party, wherein enrollment comprises receiving from the conducting party biometric identifying information of the conducting party and receiving from the conducting party personal and communication information through which the conducting party can be identified and contacted.
b) wherein the one or more computers are adapted to receive, at the authenticating party's computers, information requesting login privileges to a computer, computer network, or online computer website sent by the conducting party from the conducting party's mobile, computing, wireless, electronic, communication device containing the mobile, computing, wireless, electronic, communication device's identification information including one or more mobile phone numbers and the conducting party's biometric authentification information.
c) receiving from the authenticating computer authorization or denial to login to a computer, computer network, or an online computer website based on the authenticity of the authentification information sent by the conducting party to the authenticating computers.

9. The system according to claim 5, wherein identifying information comprises the enrollee's identification and biometric information provided by the enrolling party to the authenticating party.

10. The system according to claim 8, wherein the biometric information comprises of at least one of a voice sample of the conducting party and/or alternative biometric samples of the enrolling party.

11. The system according to claim 5, wherein the enrollment comprises the enrolling party to provide proof of identity, which is recorded by the authenticating party in electronic data format on the authenticating party's computer at the conducting party's site provided by the authenticating party.

12. The system according to claim 6, wherein, the communication information comprises of at least one or more mobile phone numbers of the conducting party.

13. The system according to claim 7, wherein all communications between the conducting party and the authenticating party is conducted through the authenticating party's computers.

14. The system according to claim 8, wherein all the conducting party's personal and biometric identification information is never held on a conducting party's mobile, computing, wireless, electronic, communication device, but stored by secure means on one or more of the authenticating party's computers.

15. The system according to claim 8, wherein a conducting party is required in order to login to a computer, computer network, or an online computer website to provide at least one or more biometric samples of the conducting party and the conducting party's mobile, computing, wireless, electronic, communication device identifiers to the authenticating party's computer

16. A machine tangible, non-transitory, readable medium adapted to store computer code that can be executed by one or more computers comprising:
a) code configured to enroll a conducting party with an authenticating party, wherein the enrollment comprises receiving from the conducting party biometric identifying information of the conducting party and receiving from the conducting party personal and communication information through which the conducting party can be identified and contacted by the authenticating party, and
b) code configured to receive, at an authenticating party's computer, information relating to a conducting party's identity, a conducting party's mobile, computing, wireless, electronic, communication device, a computer, a computer network, or an online computer website that the conducting party is requesting to login; and
c) code configured to communicate, based on the enrollment, with a conducting party to authenticate that a conducting party is a party that is authorized to login to a computer, computer network, or online computer website; and
d) code configured to transfer, based on the authentification of a conducting party, from the authenticating party's computers to a computer, computer network, or an online computer website, authorization or denial to login.

17. The machine tangible medium of claim 16, wherein identifying information comprises biometric information.

18. The machine tangible medium of claim 17, where in the biometric information comprises at least one of a voice sample of the conducting party and/or alternative biometric samples of the conducting party.

19. The machine tangible medium of claim 16, wherein the enrollment comprises filling out an electronic form by:
a) the authenticating party at the authenticating party computer site provided by the authenticating party
b) the enrolling party at the authenticating computer website or unmanned computer site provided by the authenticating party.

20. The machine tangible medium of claim 16, wherein the communication information comprises at least one or more mobile phone numbers of the conducting party.

21. The machine tangible medium of claim 16, wherein all the communication between the conducting party's mobile, computing, wireless, electronic, communication device and the authenticating party's computers is conducted by the authenticating party.

22. A machine tangible, non-transitory, readable medium adapted to store computer code by a mobile, computing, wireless, electronic, communication device that can be executed by a mobile, computing, wireless, electronic, communication device:
a) code configured to record and/or capture a conducting party's biometric identifying information through which the conducting party can be identified and contacted by the authenticating party, and
b) code configured to communicate, with an authenticating party to authenticate that a conducting party is a party that is authorized to login to a computer, computer network, or online computer website.
